(19) United States
(12) Patent Application Publication
(10) Pub. No.: US 2023/0135770 A1
(43) Pub. Date: May 4, 2023

(54) SYNCHRONIZATION MANAGEMENT SERVER, SYNCHRONIZATION MANAGEMENT SYSTEM AND SYNCHRONIZATION MANAGEMENT METHOD

(71) Applicant: INSTITUTE FOR INFORMATION INDUSTRY, TAIPEI (TW)

(72) Inventors: Hong-En CHEN, Taipei (TW); Bo Lin LEE, Taipei (TW); Hsiao-Chen CHANG, Taipei (TW); Jing-Ming CHIU, Taipei (TW)

(21) Appl. No.: 17/456,587

(22) Filed: Nov. 25, 2021

(30) Foreign Application Priority Data
Nov. 3, 2021 (TW) 110141033

(51) Int. Cl. G06F 16/176; G06F 40/166; G06Q 10/10

(52) U.S. Cl. CPC G06F 16/1774; G06F 40/166; G06Q 10/101

(57) ABSTRACT

A synchronization management server includes a processor and a memory. The processor includes a resource control circuit, a synchronization management circuit, and an editing circuit. The resource control circuit is configured to generate an initialization page and to display an initialization page according to whether a first user identity conforms to a user with editing rights and several current editing statuses corresponding to several elements, and to generate a first post-editing message, and to set a first editing status of the first element to be locked. The synchronization management circuit is configured to determine whether to update the first editing status of the first element, and to synchronize the first editing status of the first element to several electronic devices. The editing circuit is configured to update the file. The memory is configured to store the file.

### CROSS-REFERENCE TO RELATED APPLICATION

This application claims the priority benefit of TAIWAN Application serial no. 110141033, filed Nov. 3, 2021, the full disclosure of which is incorporated herein by reference.

### BACKGROUND

### Field of Invention

The invention relates to a synchronization management server, a synchronization management system and a synchronization management method. More particularly, the invention relates to a synchronization management server, a synchronization management system and a synchronization management method for collaborative conflict management.

### Description of Related Art

The elements or mechanical structure design to be processed by many machine tools/robotics can already be done through cloud design software or drawing software, but since the processing elements or mechanical structures are often complex, it requires several people to design together or to design separately and then combine them. In the cloud design/drawing software, the cloud server is usually required to run the software system. The user-end device still needs to install the corresponding operating software, and the corresponding operating software is configured to interface with the cloud server, so as to display and operate the related elements. The development cost of such systems is quite high, and although files can be stored in the cloud, files can be shared with others but cannot be edited together. Therefore, it is not conducive to collaboration, and more convenient collaboration solutions are needed.

### SUMMARY

An aspect of this disclosure is to provide a synchronization management server. The synchronization management server is configured to let several electronic devices edit a file synchronously. The file includes several elements, and each one of several elements corresponds to a user with editing rights, wherein the synchronization management server includes a processor and a memory. The processor includes a resource control circuit, a synchronization management circuit, and an editing circuit. The resource control circuit is configured to generate an initialization page according to a first user identity transmitted by a first electronic device of several electronic devices, to transmit the initialization page to the first electronic device to display several elements and several editing statuses corresponding to each of several elements, and to display the initialization page according to whether the first user identity conforms to the user with editing rights of several elements and several current editing statuses corresponding to several elements, and to generate a first post-editing message when the first electronic device receives a first editing status with an editing instruction of a first element being unlocked, and to set a first editing status of the first element to be locked. The synchronization management circuit is configured to determine whether to update the first editing status of the first element according to the first post-editing message transmitted by the first electronic device, and to synchronize the first editing status of the first element to several electronic devices. The editing circuit is configured to update the file according to the first post-editing message. The memory is coupled to the processor, and the memory is configured to store the file.

Another aspect of this disclosure is to provide a synchronization management system includes several electronic devices and a synchronization management server. The synchronization management server is coupled to several electronic devices. The synchronization management server includes a memory, a resource control circuit, a synchronization management circuit, and an editing circuit. The memory is configured to store a file. The file includes several elements, and each of several elements corresponds to a user with editing rights. The resource control circuit is configured to generate an initialization page according to a first user identity transmitted by a first electronic device of several electronic devices, to transmit the initialization page to the first electronic device to display several elements and several editing statuses corresponding to each of several elements, and to display according to whether the first user identity conforms to the user with editing rights of several elements and several current editing statuses corresponding to several elements, and to generate a first post-editing message when the first electronic device receives a first editing status with an editing instruction of a first element is unlocked, and to set a first editing status of the first element to be locked. The synchronization management circuit is configured to determine whether to update the first editing status of the first element according to the first post-editing message transmitted by the first electronic device, and to synchronize the first editing status of the first element to several electronic devices. The editing circuit, configured to update the file according to the first post-editing message.

A synchronization management method, configured to make several electronic devices edit a file synchronously, wherein the file includes several elements, and each one of several elements corresponds to a user with editing rights. The synchronization management method includes the following operations: generating an initialization page by a synchronization management server according to a first user identity transmitted by a first electronic device of several electronic devices, and transmitting the initialization page to the first electronic device to display several editing statuses of several elements; displaying the initialization page according to whether the first user identity conforms to the user with editing rights of each of several elements and several current editing statuses corresponding to several elements, and generating a first post-editing message with an editing instruction of a first element is unlocked when the first electronic device receives a first editing status, and setting a first editing status of the first element to be locked; determining whether to update the first editing status of the first element, and synchronizing the first editing status of the first element to several electronic devices according to the first post-editing message transmitted by the first electronic device by the synchronization management server; updating the file according to the first post-editing message by the synchronization management server; and storing the file by the synchronization management server.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a schematic diagram illustrating a synchronization management system according to some embodiments of the present disclosure.

FIG. 2 is a flowchart illustrating a synchronization management method according to some embodiments of the present disclosure.

FIG. 3 is a schematic diagram illustrating an initialization page according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

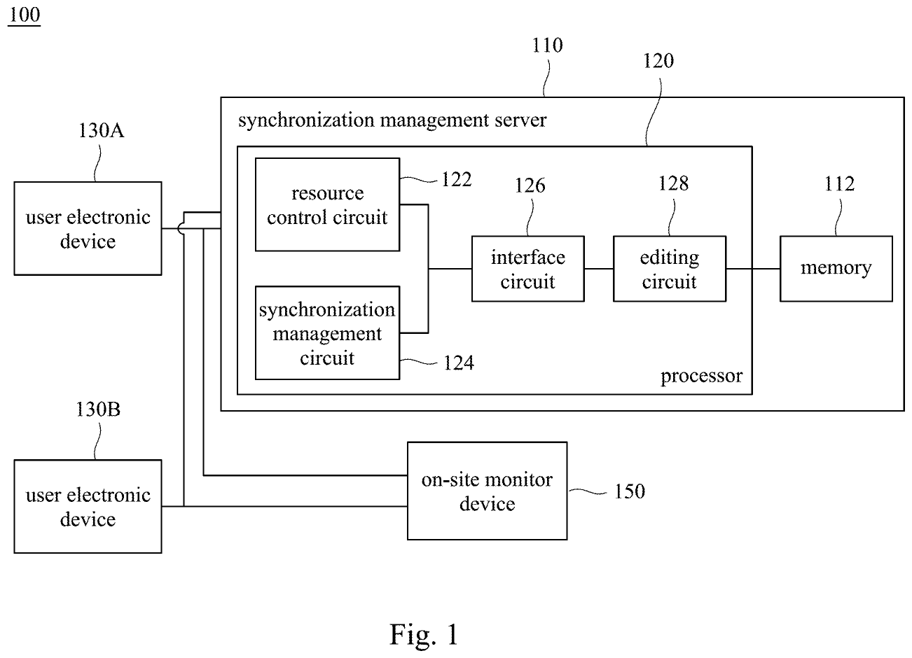

Reference is made to FIG. 1. FIG. 1 is a schematic diagram illustrating a synchronization management system 100 according to some embodiments of the present disclosure. As illustrated in FIG. 1, the synchronization management system 100 includes the synchronization management server 110 and the electronic devices 130A and 1308. In the connection relationship, the synchronization management server 110 and the electronic devices 130A and 1308 couple to each other.

In some embodiments, the synchronization management server 110 includes the memory 112 and the processor 120. The memory 112 couples to the processor 120.

The processor 120 includes the resource control circuit 122, the synchronization management circuit 124, the interface circuit 126 and the editing circuit 128. In the connection relationship, the resource control circuit 122 couples to the interface circuit 126, the synchronization management circuit 124 couples to the interface circuit 126, the interface circuit 126 couples to the editing circuit 128.

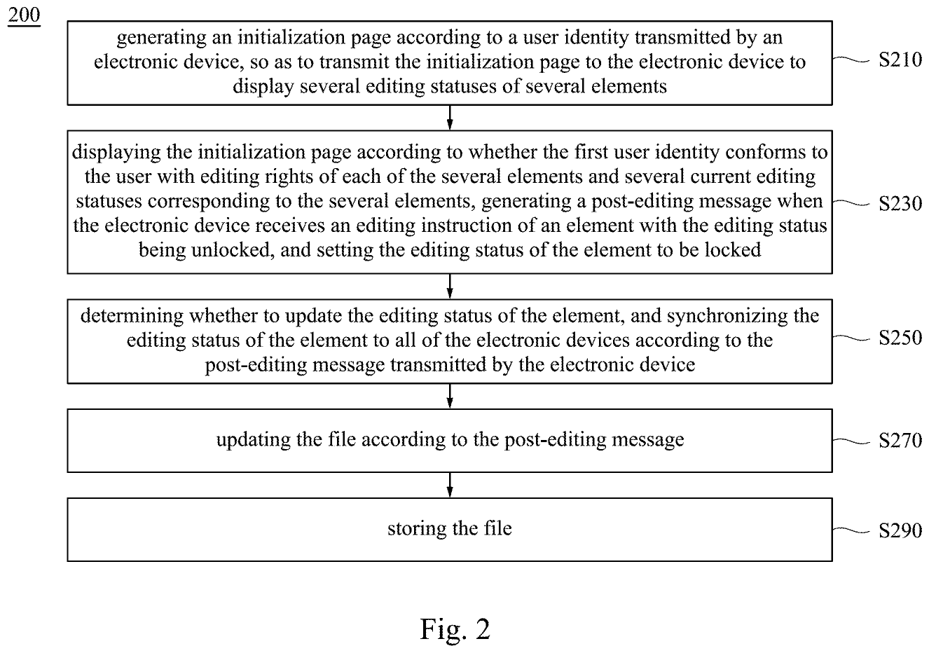

The synchronization management system 100 as illustrated in FIG. 1 is for illustrative purposes only, and the embodiments of the present disclosure are not limited thereto. For the operation method of the synchronization management system 100, reference is made to FIG. 2 below.

Reference is made to FIG. 2. FIG. 2 is a flowchart illustrating a synchronization management method 200 according to some embodiments of the present disclosure. The embodiments of the present disclosure are not limited thereto.

It should be noted that, this synchronization management method 200 can be applied to a system with the same or similar structure as the synchronization management system 100 in FIG. 1. To make the description simple, the following will take FIG. 1 as an example to describe the operation method, but the embodiments of the present disclosure are not limited to the application of FIG. 1.

It should be noted that, in some embodiments, the synchronization management method 200 can also be implemented as a computer program and stored in a non-transitory computer readable medium, so that the computer, the electronic device, or the aforementioned synchronization management system 100 as shown in FIG. 1 can perform this operation method after reading this recording media. The non-transitory computer-readable recording media can be read-only memory, flash memory, floppy disks, hard disks, optical disks, flash drives, tapes, databases that can be accessed over the Internet, or a non-transitory computer with the same function can read the recording medium those who are familiar with this technology can easily think of.

In addition, it should be noted that the operations of the synchronization management method 200 mentioned in this embodiment can be adjusted according to actual needs, and can even be performed at the same time or partly, unless the order is specifically stated.

Furthermore, in different embodiments, these operations may also be adaptively added, replaced, and/or omitted.

Reference is made to FIG. 2. The synchronization management method 200 includes the following operations and can be executed by the synchronization management server 110.

In operation S210, the synchronization management server 110 generates an initialization page according to a user identity transmitted by an electronic device, so as to transmit the initialization page to the electronic device to display several editing statuses of several elements. Reference is made to FIG. 1 together, in some embodiments, operation S210 may be executed by the resource control circuit 122 of the processor 120 of the synchronization management server 110 in FIG. 1.

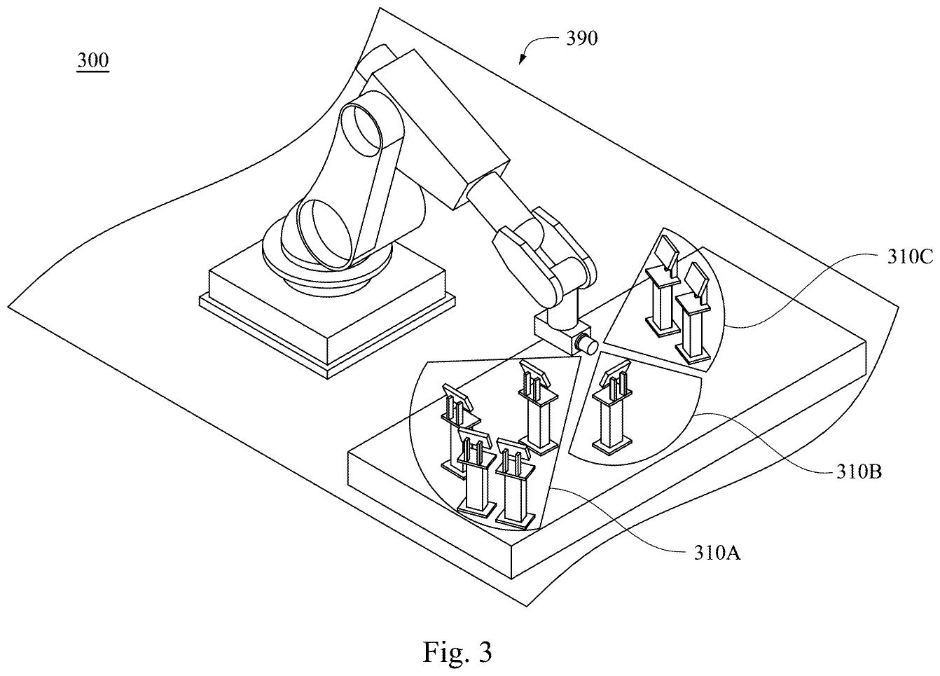

Reference is made to FIG. 3 together. FIG. 3 is a schematic diagram illustrating an initialization page 300 according to some embodiments of the present disclosure. The initialization page 300 displayed includes at least elements 310A, 310B, 310C and the page of the file 390. In some embodiments, each of the elements 310A, 310B, and 310C corresponds to a user with editing rights. That is, each of elements 310A, 310B, and 310C can only be edited by one user at the same time. In some embodiments, the memory 112 is configured to store the file 390 which includes several elements 310A, 310B, and 310C.

Reference is made to FIG. 1 together. In some embodiments, when the first user wants to edit the file 390 in FIG. 3 through the electronic device 130A, the electronic device 130A sends the first user identity corresponding to the first user to generate the initialization page 300. As illustrated in FIG. 3, the elements 310A, 310B, 310C and their respective editing status are displayed on the initialization page 300. For example, the initialization page 300 can display that the editing status of element 310B is edited by the second user, and the editing status of the element 310C is edited by the third user.

In some embodiments, for example, the memory 112 in FIG. 1 stores several elements 310A, 310B, 310C in FIG. 3 and their respective editing statuses and the corresponding users with editing rights. When the first user wants to edit the file 390 in FIG. 3 through the electronic device 130A, the initialization page 300 includes several editing instructions for the first user to select the required editing instruction and the element to be edited. For example, the resource control circuit 122 in FIG. 1 is configured to compare whether the first user identity is one of the users with editing rights of each of the several elements 310A, 310B, and 310C. The following takes element 310A as an example. When the first user identity is one of the users with editing rights of the element 310A and the processor 120 has not received the post-editing message corresponding to the element 310A transmitted from other electronic devices, the current editing status of the element 310A is set to be unlocked.

In some embodiments, when the first user wants to edit the file 390 in FIG. 3 through the electronic device 130A, the resource control circuit 122 in FIG. 1 is further configured to distribute the edit resource to the electronic device 130A. In some embodiments, the resources include computer-aided design (CAD/CAM) software, but the embodiments of the present disclosure are not limited to the above-mentioned software.

In some embodiments, the resource control circuit 122 is further configured to check and confirm whether the edit resource has been distributed to the electronic device 130A, and the resource control circuit 122 is configured to confirm whether the edit resource is successfully activated on the electronic device 130A. In some embodiments, after the resource control circuit 122 distributes the resources, the user can operate through the browser of the electronic device 130A without downloading the operating system.

Reference is made to FIG. 2 again. In operation S230, the synchronization management server 110 is displayed according to whether the user identity conforms to the user with editing rights of each of several elements and the current editing statuses corresponding to the several elements, and when the electronic device receives the editing instruction of the element whose editing status is unlocked, a post-editing message is generated, and the editing status of the element is set to locked. In some embodiments, operation S230 is executed by the resource control circuit 122 of the processor 120 in FIG. 1.

Reference is made to FIG. 1 and FIG. 3 together. For example, when the first user wants to obtain file 390 in FIG. 2 through electronic device 130A, the processor in FIG. 1 determines whether the first user matches the users with editing rights of the elements 310A, 310B, and 310C in file 390, that is, whether the first user can edit the file 390. If it is determined that a user can edit the file 390, the electronic device 130A displays the initialization page.

Since the second user is editing the element 310B when the first user obtains the initialization page via the electronic device 130A, the element 310B is locked. Since the third user is editing the element 310C, the element 310C is locked. At this time, only the editing the element 310A is not locked yet. The first user can only select and edit the element 310A that has not been locked. If there are other elements that have not been locked, the first user can also select other elements that have not been locked.

After the first user edits the element 310A via the electronic device 130A, the electronic device 130A generates a post-editing message when it receives an editing instruction of the element 310A whose editing status is unlocked. After receiving the post-editing message, the synchronization management circuit 124 in FIG. 1 sets the editing status of the element 310A to be locked.

Reference is made to FIG. 2 again. In operation S250, the synchronization management server 110 determines whether to update the editing status of the element according to the post-editing message sent by the electronic device, and the synchronization management server 110 synchronizes the editing status of the element to all electronic devices. In some embodiments, the operation S250 can be executed by the synchronization management circuit 124 of the processor 120 in FIG. 1.

For example, after the synchronization management circuit 124 receives the post-editing message transmitted by the electronic device 130A after editing element the 310A, the synchronization management circuit 124 determines whether the post-editing message includes the editing instruction corresponding to the element 310A and the store instruction corresponding to the element 310A. If the synchronization management circuit 124 determines that the editing instruction and the store instruction corresponding to the element 310A are received and the editing status of the element 310A is locked, after the editing circuit 128 updates the file to the memory 112, the synchronization management circuit 124 updates the editing status of the element 310A to be unlocked. The synchronization management circuit 124 also updates the editing status of the element 310A to all other user devices, such as the electronic device 130B.

In some embodiments, the store instruction is generated after the first user finishes editing the element 310A via the electronic device 130A, and the store instruction is used as the post-editing message transmitted by the editing circuit 128 to update the file 390.

In another embodiment, if the synchronization management circuit 124 receives the post-editing message corresponding to the element 310A from the first user via the electronic device 130A but has not synchronized the editing status of the element 310A, it also receives the post-editing message corresponding to the element 310A from the second user via the electronic device 130B, the synchronization management circuit 124 is further configured to update the editing status of the element 310A according to the transfer time of the post-editing message sent by the electronic device 130A and the transfer time of the post-editing message sent by the electronic device 130B. When the synchronization management circuit 124 adopts the first-in-first-out (FIFO) mechanism, it will update according to the earlier transfer time.

In operation S270, the synchronization management server 110 updates the file according to the post-editing message. In some embodiments, the operation S270 is executed by the editing circuit 128 of the processor 120 in FIG. 1. For example, when the editing status of the element 310A is locked, the editing circuit 128 stores the edited element 310A in the memory 112 according to the store instruction in the post-editing message corresponding to the element 310A.

In some embodiments, after the editing circuit 128 stores the edited element 310A in the memory 112 according to the store instruction in the post-editing message corresponding to the element 310A to update the file 390, the synchronization management circuit 124 is further configured to update the editing status of the element 310A to be unlocked.

In operation S290, the synchronization management server 110 stores the file. Reference is made to FIG. 1 and FIG. 2 together. In some embodiments, the file 390 in FIG. 2 is stored by the memory 112 of the synchronization management server 110 in FIG. 1.

Reference is made to FIG. 1 again. In some embodiments, the processor 120 further includes the interface circuit 126. The interface circuit 126 couples between the resource control circuit 122, the synchronization management circuit 124 and the editing circuit 128. The interface circuit 126 is configured to send the messages sent by the resource control circuit 122 and the synchronization management circuit 124 to the editing circuit 128.

In some embodiments, the synchronization management system 100 further includes the on-site monitor device 150. The on-site monitor device 150 is configured to generate real-time images based on the machine (not shown) corresponding to the file 390 in FIG. 3, and send the real-time images to the electronic devices 130A and 130B. The on-site monitor device 150 can be a processor or an industrial computer integrated with hardware and software, which can be connected to the machine. The synchronization management system 100 can further convert the designed element into a machine program file that can be read and executed by the machine, and sent to the machine for execution. When the machine starts to execute the machine program file, the on-site monitor device 150 can start a camera to take a real-time image of the machine running the machine program file, and then the on-site monitor device 150 sends the image to the electronic devices 130A and 130B.

In some embodiments, the circuits in the synchronization management server 110 may be located in the same server or may be located in different servers. That is, the synchronization management server 110 can be composed of different servers.

In some embodiments, the processor 120 can be a server or other devices. In some embodiments, the processor 120 can be a server, a circuit, a central processing unit (CPU), a microprocessor (MCU), or other functional device with functions such as storage, calculation, data reading, signals or messages receiving, and signals or messages transmitting.

In some embodiments, the on-site monitor device 150 can be an element with functions such as real-time image photography and transmission, or an element with similar functions. The on-site monitor device 150 can be an element with functions such as real-time image photography and transmission, or an element with similar functions.

In some embodiments, the synchronization management server 110 is a server or computer equipment that installs the stand-alone computer graphics software. The synchronization management server 110 is communicatively connected to several electronic devices via a communication network, and the initialization page provided by the synchronization management server 110 is a web interface. The initialization page is sent to the operation interface of the electronic device to be displayed, the web interface is configured to display the stand-alone computer graphics software and to receive the operation instructions of the several users of the electronic devices, and then the operation instructions are sent back to the synchronization management server 110.

According to the embodiment of the present disclosure, it is understood that the embodiment of the present disclosure is to provide a synchronization management server, a synchronization management system and a synchronization management method. By distributing resources from the synchronization management server to the electronic devices, the system operations can be performed across operating environments without downloading files to the electronic device. Furthermore, several users can edit the same file synchronously, several electronic devices are updated synchronously through the broadcast mechanism, and the same element can be prevented from being edited by different users at the same time. In addition, the on-site monitor device allows users to directly connect to the video device for real-time processing status monitoring.

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In addition, the above illustrations include sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A synchronization management server, configured to let a plurality of electronic devices edit a file synchronously, wherein the file comprises a plurality of elements, and each one of the plurality of elements corresponds to a user with editing rights, wherein the synchronization management server comprises:
a processor, comprising:
a resource control circuit, configured to generate an initialization page according to a first user identity transmitted by a first electronic device of the plurality of electronic devices, to transmit the initialization page to the first electronic device to display the plurality of elements and a plurality of editing statuses corresponding to each of the plurality of elements, and to display the initialization page according to whether the first user identity conforms to the user with editing rights of the plurality of elements and a plurality of current editing statuses corresponding to the plurality of elements, and to generate a first post-editing message when the first electronic device receives a first editing status with an editing instruction of a first element being unlocked, and to set a first editing status of the first element to be locked;
a synchronization management circuit, configured to determine whether to update the first editing status of the first element according to the first post-editing message transmitted by the first electronic device, and to synchronize the first editing status of the first element to the plurality of electronic devices; and
an editing circuit, configured to update the file according to the first post-editing message; and
a memory, coupled to the processor, and configured to store the file.

2. The synchronization management server of claim 1, wherein the first post-editing message comprises the editing instruction corresponding to the first element, and the first electronic device corresponding to a store instruction of the first element, the synchronization management circuit is further configured to update the first editing status corresponding to the first element of the plurality of electronic devices to be locked when receiving the editing instruction corresponding to the first element, and when the store instruction corresponding to the first element of the first electronic device is received, the editing circuit updates the file and the synchronization management circuit updates the first editing status corresponding to the first element of the plurality of electronic devices to be unlocked.

3. The synchronization management server of claim 1, wherein the plurality of current editing statuses is the plurality of editing statuses of the synchronization management circuit synchronizing the plurality of elements when the resource control circuit is generating the initialization page and when the first electronic device is transmitting the first post-editing message.

4. The synchronization management server of claim 1, wherein each one of the plurality of elements stored in the memory corresponds to a plurality of users with editing rights, and the resource control circuit is further configured to compare whether the first user identity is one of the plurality of users with editing rights of the plurality of elements, when the first user identity is one of the plurality of users with editing rights of the plurality of elements and a post-editing message transmitted by other electronic devices is not received, the plurality of current editing statuses of the plurality of elements is set to be unlocked.

5. The synchronization management server of claim 1, wherein after the synchronization management circuit receives the first post-editing message and the first editing status of the first element is not yet synchronized, and when a second post-editing message transmitted by a second electronic device of the plurality of electronic devices is also corresponding to the first element, the synchronization management circuit is further configured to update the first editing status according to a first transfer time of the first post-editing message and a second transfer time of the second post-editing message of the first element.

6. The synchronization management server of claim 1, wherein the resource control circuit is further configured to distribute an edit resource to the first electronic device.

7. The synchronization management server of claim 2, wherein the first electronic device generates the store instruction after finish editing the first element, and the store instruction is used as the first post-editing message to transmit to the editing circuit to update the file, and the synchronization management circuit is further configured to update the first editing status of the first element to be unlocked after the editing circuit updates the file according to the first post-editing message.

8. A synchronization management system, comprising:
a plurality of electronic devices; and
a synchronization management server, coupled to the plurality of electronic devices, wherein the synchronization management server comprises:
a memory, configured to store a file, wherein the file comprises a plurality of elements, and each of the plurality of elements corresponds to a user with editing rights;
a resource control circuit, configured to generate an initialization page according to a first user identity transmitted by a first electronic device of the plurality of electronic devices, to transmit the initialization page to the first electronic device to display the plurality of elements and a plurality of editing statuses corresponding to each of the plurality of elements, and to display according to whether the first user identity conforms to the user with editing rights of the plurality of elements and a plurality of current editing statuses corresponding to the plurality of elements, and to generate a first post-editing message when the first electronic device receives a first editing status with an editing instruction of a first element is unlocked, and to set a first editing status of the first element to be locked;
a synchronization management circuit, configured to determine whether to update the first editing status of the first element according to the first post-editing message transmitted by the first electronic device, and to synchronize the first editing status of the first element to the plurality of electronic devices; and
an editing circuit, configured to update the file according to the first post-editing message.

9. The synchronization management system of claim 8, wherein the first post-editing message comprises the editing instruction corresponding to the first element, wherein the first electronic device corresponds to a store instruction of the first element, and the synchronization management circuit is further configured to update the first editing status corresponding to the first element of the plurality of electronic devices to be locked when receiving the editing instruction corresponding to the first element, and when the store instruction corresponding to the first element of the first electronic device is received, the editing circuit updates the file and the synchronization management circuit updates the first editing status corresponding to the first element of the plurality of electronic devices to be unlocked.

10. The synchronization management system of claim 8, wherein after the synchronization management circuit receives the first post-editing message and the first editing status of the first element is not yet synchronized, and when a second post-editing message transmitted by a second electronic device of the plurality of electronic devices is also corresponding to the first element, the synchronization management circuit is further configured to update the first editing status according to a first transfer time of the first post-editing message and a second transfer time of the second post-editing message of the first element.

11. The synchronization management system of claim 8, wherein the plurality of current editing statuses is the plurality of editing statuses of the synchronization management circuit synchronizing the plurality of elements when the resource control circuit is generating the initialization page and when the first electronic device is transmitting the first post-editing message.

12. The synchronization management system of claim 9, wherein the store instruction is generated after the first electronic device finishes editing the first element, and the store instruction is used as the first post-editing message to transmit to the editing circuit to update the file, and the synchronization management circuit is further configured to update the first editing status of the first element to be unlocked after the editing circuit updates the file according to the first post-editing message.

13. The synchronization management system of claim 8, wherein the resource control circuit is further configured to distribute an edit resource to the first electronic device.

14. The synchronization management system of claim 8, wherein the synchronization management system is further configured to install a stand-alone computer graphics software, and the initialization page is a web interface, configured to display an operation interface of the stand-alone computer graphics software.

15. A synchronization management method, configured to make a plurality of electronic devices edit a file synchronously, wherein the file comprises a plurality of elements, and each one of the plurality of elements corresponds to a user with editing rights, wherein the synchronization management method comprises:
generating an initialization page by a synchronization management server according to a first user identity transmitted by a first electronic device of the plurality of electronic devices, and transmitting the initialization page to the first electronic device to display a plurality of editing statuses of the plurality of elements;
displaying the initialization page according to whether the first user identity conforms to the user with editing rights of each of the plurality of elements and a plurality of current editing statuses corresponding to the plurality of elements, and generating a first post-editing message with an editing instruction of a first element is unlocked when the first electronic device receives a first editing status, and setting a first editing status of the first element to be locked;
determining whether to update the first editing status of the first element, and synchronizing the first editing status of the first element to the plurality of electronic devices according to the first post-editing message transmitted by the first electronic device by the synchronization management server;
updating the file according to the first post-editing message by the synchronization management server; and
storing the file by the synchronization management server.

16. The synchronization management method of claim 15, wherein the first post-editing message comprises the editing instruction corresponding to the first element and a store instruction corresponding to the first element of the first electronic device, wherein the synchronization management method further comprises:
updating the first editing status corresponding to the first element of the plurality of electronic devices to be locked by the synchronization management server when receiving the editing instruction corresponding to the first element, and updating the file by an editing circuit and updating the first editing status corresponding to the first element of the plurality of electronic devices to be unlocked by the synchronization management server when receiving the store instruction of the first electronic device corresponding to the first element.

17. The synchronization management method of claim 15, further comprising:
updating the first editing status according to a first transfer time of the first post-editing message and a second transfer time of a second post-editing message of the first element by the synchronization management server after a synchronization management circuit receives the first post-editing message and the first editing status of the first element is not yet synchronized and when the second post-editing message transmitted by a second electronic device of the plurality of electronic devices is also corresponding to the first element.

18. The synchronization management method of claim 15, further comprising:
distributing an edit resource to the first electronic device by the synchronization management server.

19. The synchronization management method of claim 16, wherein the first electronic device further generates the store instruction after finish editing the first element, and the store instruction is used as the first post-editing message to transmit to the editing circuit to update the file, and a synchronization management circuit is further configured to update the first editing status of the first element to be unlocked after the editing circuit updates the file according to the first post-editing message.

20. The synchronization management method of claim 15, wherein the synchronization management server further installs a stand-alone computer graphics software, and the initialization page is a web interface configured to display an operation interface of the stand-alone computer graphics software.
